(19) United States
(12) Patent Application Publication
(10) Pub. No.: US 2025/0249833 A1
(43) Pub. Date: Aug. 7, 2025

(54) ELECTRIC STEP WITH LOCKING FUNCTION

(71) Applicant: T-MAX (HANGZHOU) TECHNOLOGY CO., LTD., Hangzhou (CN)

(72) Inventors: Yongyong ZHAN, Hangzhou (CN); Ke WANG, Hangzhou (CN); Xinfa DU, Hangzhou (CN); Tao HE, Hangzhou (CN); Yiming WANG, Hangzhou (CN)

(21) Appl. No.: 18/798,058

(22) Filed: Aug. 8, 2024

(30) Foreign Application Priority Data
Feb. 1, 2024 (CN) 202420252298.4

(51) Int. Cl. B60R 3/02

(52) U.S. Cl. CPC B60R 3/02

(57) ABSTRACT

An electric step with a locking function includes a step, a telescoping mechanism, and a locking device. The step is adapted to be mounted on a vehicle, and the telescoping mechanism is mounted on the vehicle and coupled to the step. The telescoping mechanism is configured to drive the step to move between a first position and a second position relative to the vehicle. When the step is in the first position, the step exhibits an extended state. When the step is in the second position, the step exhibits a retracted state. There is an angle between the first position and the second position. The locking device is arranged on the telescoping mechanism, and the locking device is configured to lock the step at the first position, the second position, or any position between the first position and the second position.

### CROSS-REFERENCE TO RELATED APPLICATIONS

This patent document claims priority to and benefits of Chinese Application No. 202420252298.4, filed on Feb. 1, 2024. The entire content of the aforementioned patent document is incorporated by reference for all purposes.

### TECHNICAL FIELD

The present disclosure relates to the field of electric steps, and more particularly to an electric step with a locking function.

### BACKGROUND

Electric steps of automobiles are automobile step pedals that can automatically extend and retract. When a vehicle door opens, the automobile step pedal extends, allowing people to step on; and when the vehicle door closes, the automobile step pedal retracts. However, existing electric steps of automobiles have no locking mechanism; thus, when people step on the pedal, the pedal transfers the user's stepping force it receives to a telescoping mechanism that controls the extension and retraction of the pedal, thereby causing internal parts of the telescoping mechanism to be easily damaged. An electric step with a mechanism to mitigate or prevent damage to the telescoping mechanism is needed to improve the durability and overall function of electric steps for automobiles.

### SUMMARY

Disclosed is an electric step with a locking feature, in accordance with the present technology, which alleviates the aforementioned problems and provides advantages and benefits that improve the durability and overall function of electric steps for automobiles.

In some aspects, an electric step with a locking function according to embodiments of the present technology includes: a step adapted to be mounted on a vehicle; a telescoping mechanism mounted on the vehicle and coupled to the step, the telescoping mechanism being configured to drive the step to move between a first position and a second position relative to the vehicle, wherein when the step is in the first position, the step exhibits an extended state, and when the step is in the second position, the step exhibits a retracted state, and wherein there is an angle between the first position and the second position; and a locking device arranged on the telescoping mechanism and configured to lock the step at the first position, the second position, or any position between the first position and the second position.

### BRIEF DESCRIPTION OF THE DRAWINGS

FIG. 1 is an exploded view of a first embodiment of an electric step with a locking function according to embodiments of the present technology.

FIG. 2 is a schematic view of coordination between a toggle member and a limiting member of an electric step with a locking function according to embodiments of the present technology.

FIG. 3 is a schematic view of a second embodiment of an electric step with a locking function according to embodiments of the present technology.

FIG. 4 is a schematic view of a third embodiment of an electric step with a locking function according to embodiments of the present technology.

FIG. 5 is a schematic view of a fourth embodiment of an electric step with a locking function according to embodiments of the present technology.

### DETAILED DESCRIPTION

Embodiments of the present technology are described in detail below, and examples of the embodiments are shown in accompanying drawings. The embodiments described below with reference to the accompanying drawings are illustrative and are intended to be used to explain the present technology and cannot be understood as limitation of the present technology.

The present technology aims to solve at least one of the problems existing in the related art to at least some extent. Accordingly, embodiments of the present technology provide an electric step with a locking function, which has advantages of structural stability and strong load-bearing capacity.

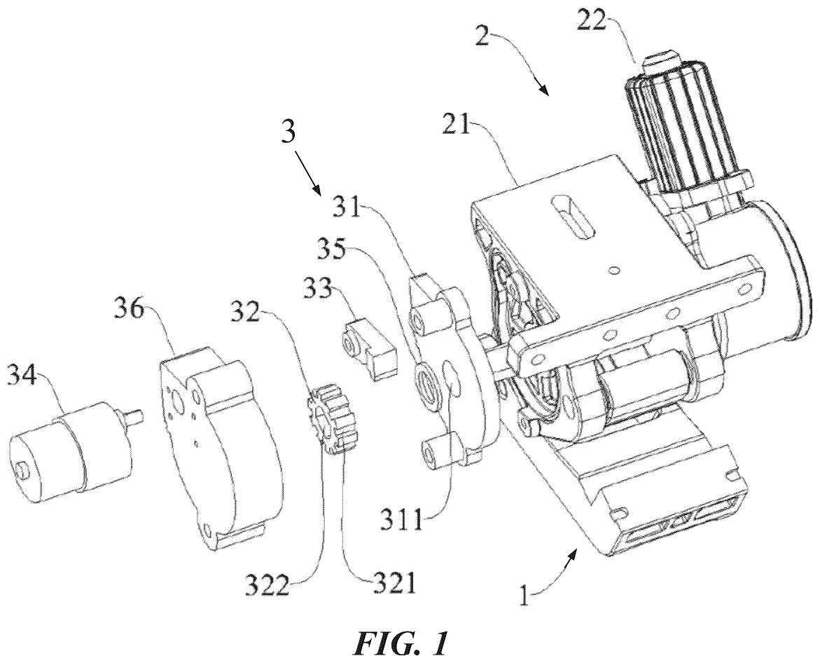

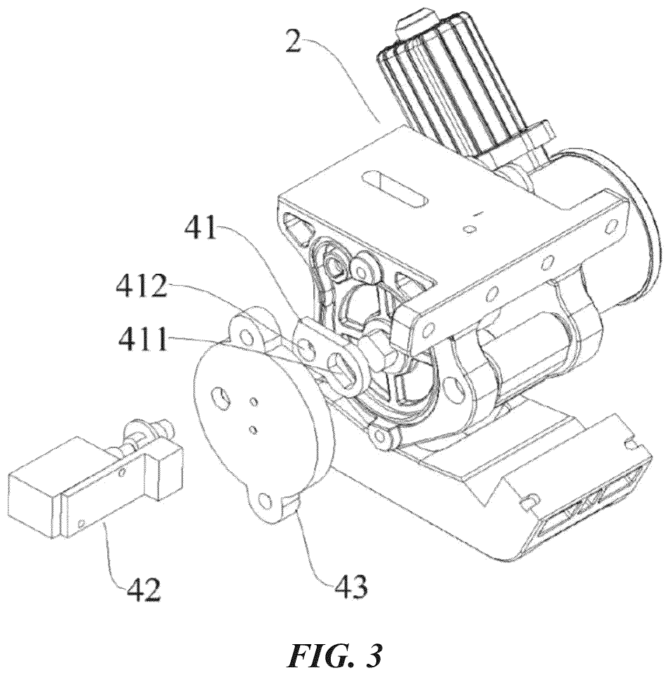

FIGS. 1-5 shows an electric step with a locking function according to embodiments of the present technology. The electric step includes a step 1, a telescoping mechanism 2, and a locking device 3. The step 1 is adapted to be mounted on a vehicle. The telescoping mechanism 2 is mounted on the vehicle and coupled to the step 1. The telescoping mechanism 2 is configured to drive the step 1 to move between a first position (not shown) and a second position (not shown) relative to the vehicle. When the step 1 is in the first position, the step 1 exhibits an extended state to allow a user to step on it when getting on and off the vehicle. When the step 1 is in the second position, the step 1 exhibits a retracted state so that the step 1 would not collide with surrounding objects while the vehicle is in motion. There is an angle between the first position and the second position, and the angle is greater than 0 degree. For instance, the angle between the first position and the second position can allow the step 1 to be extended and positioned outward and downward with respect to the vehicle (e.g., away from the vehicle and toward the ground), which can assist in allowing a variety of users of various heights, ages, and/or stepping abilities to use the step 1 of the electric step to get into the vehicle or out of the vehicle. Some non-limiting examples of the angle between the first position and the second position include up to 0.5°, up to 1°, up to 2°, up to 5°, up to 10°, up to 15°, up to 20°, up to 25°, up to 30°, up to 35°, up to 40°, up to 45°, up to 50°, up to 55°, or up to another angle greater than 55°. The locking device 3 is arranged on the telescoping mechanism 2 and configured to lock the step 1 in the first position, the second position, or any position between the first position and the second position.

For the electric step with the locking function, according to embodiments of the present technology, the telescoping mechanism 2 drives the step 1 to move between the first position and the second position so that the user can step on the step 1 in different states. The arrangement of the locking device 3 not only ensures that the step 1 in any position can remain stable but also allows the force received by the step 1, when it is stepped on, to act on the locking device 3, e.g., thereby improving the bearing capacity of the step 1 and protecting internal parts of the telescoping mechanism 2 from being damaged.

In some embodiments, the locking device 3 includes a connecting plate 31, a limiting member 32, a toggle member 33, and a driving member 34. The connecting plate 31 is arranged on the telescoping mechanism 2, and a first end of an active shaft of the telescoping mechanism 2 passes through the connecting plate 31 along a thickness direction of the connecting plate 31. Specifically, the active shaft of the telescoping mechanism 2 controls the extension and retraction of the step 1 by rotating around its own extension direction. A middle position of the connecting plate 31 is provided with a perforation 311, which runs through the connecting plate 31 along the thickness direction of the connecting plate 31. The first end of the active shaft of the telescoping mechanism 2 can pass through the perforation 311.

The limiting member 32 is on a side of the connecting plate 31 away from the telescoping mechanism 2 and coupled to the first end of the active shaft. The limiting member 32 can rotate with the active shaft of the telescoping mechanism 2 relative to the connecting plate 31. An outer peripheral surface of the limiting member 32 has a recess 321. Specifically, a middle position of the limiting member 32 has an elongated hole 322, a cross section of the first end of the active shaft of the telescoping mechanism 2 is in a long strip shape, and the first end of the active shaft is adapted to the elongated hole 322 so that the limiting member 32 and the active shaft of the telescoping mechanism 2 are stably fitted, and relative motion between the limiting member 32 and the active shaft of the telescoping mechanism 2 will not easily occur.

The toggle member 33 is arranged on the side of the connecting plate 31 away from the telescoping mechanism 2. The toggle member 33 is rotatable relative to the connecting plate 31, and at least a part of the toggle member 33 is fitted with the recess 321. The driving member 34 is coupled to the toggle member 33, and the driving member 34 is configured to drive the toggle member 33 to rotate, so that at least a part of the toggle member 33 is fitted with the recess 321 or detached from the recess 321. In some embodiments, for example, the driving member 34 is a motor.

Specifically, when the driving member 34 drives at least a part of the toggle member 33 to fit with the recess 321, the toggle member 33 can restrict rotation of the limiting member 32 relative to the connecting plate 31, thereby restricting rotation of the active shaft of the telescoping mechanism 2 and keeping the step 1 stable at a certain position. When the driving member 34 drives at least a part of the toggle member 33 to detach from the recess 321, the toggle member 33 does not have a position-limiting effect on the limiting member 32. The limiting member 32 can rotate with the active shaft of the telescoping mechanism 2, allowing the step 1 to move between the first position and the second position. Thereby, the step 1 is restricted by driving the toggle member 33 through the driving member 34, which not only simplifies manners of operation and has a good locking effect but also allows the force that the step 1 received when stepped on to act on the toggle member 33, e.g., thereby avoiding the force that the step 1 received from being transmitted to internal parts of the telescoping mechanism 2 and thus protecting the internal parts of the telescoping mechanism 2 from being damaged. Moreover, other example advantages of the example embodiment of the electric step is that the locking device 3 has a simple structure for manufacturability (e.g., low cost) and can be easy to assemble.

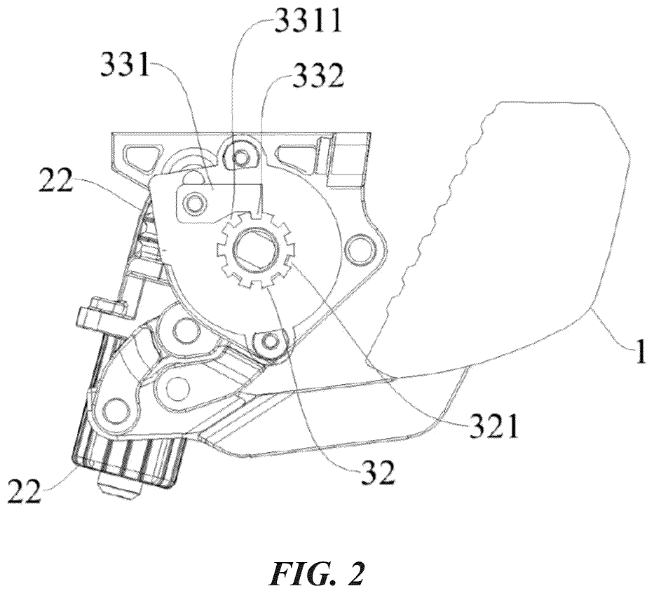

In some embodiments, the limiting member 32 includes a plurality of recesses 321 (like that shown in the drawings of FIGS. 1 and 2), and the plurality of recesses 321 are arranged at intervals around a peripheral direction of the outer peripheral surface of the limiting member 32. For example, the outer peripheral surface of the limiting member 32 can be cylindrical, and the plurality of recesses 321 can be arranged at equal intervals around the outer peripheral surface of the limiting member 32. In such embodiments, for example, at least a part of the toggle member 33 can fit with different recesses 321 so that the locking device 3 has a plurality of locking positions, thereby allowing the step 1 to have different position states.

In some embodiments, for example, a cross-sectional area of the recess 321 gradually decreases from a first end of the recess 321 away from a center of the limiting member 32 to a second end of the recess 321 adjacent to the center of the limiting member 32, which allows at least a part of the toggle member 33 to be inserted into the recess 321 more easily.

In some embodiments, for example, the toggle member 33 includes a body 331 and an insertion block 332, as shown in FIG. 2. A first end of the body 331 is rotatably coupled to the side of the connecting plate 31 away from the telescoping mechanism 2, and the insertion block 332 is arranged at a second end of the body 331 and is fitted with the recess 321.

Specifically, the body 331 is positioned above the limiting member 32, and the insertion block 332 is positioned on a side of the body 331 adjacent to the limiting member 32. The driving member 34 (e.g., motor, not shown in FIG. 2) is coupled to the first end of the body 331 and drives the first end of the body 331 to rotate, so as to drive the second end of the body 331 to rotate, thereby driving the insertion block 332 to move in a circular motion with the first end of the body 331 as a circle center and with the length direction of the body 331 as a radius. In some embodiments, a rotation angle of the insertion block 332 is 90 degrees.

In some embodiments, for example, a cross-sectional area of the insertion block 332 gradually decreases from a first end of the insertion block 332 adjacent to the body 331 to a second end of the insertion block 332 away from the body 331, making it easier for the insertion block 332 to be inserted into the recess 321 to fit with the recess 321. The insertion block 332 is adapted to the recess 321 so that the insertion block 332 is mounted stably in the recess 321 and is difficult to detach from the recess 321.

In some embodiments, for example, the side of the body 331 adjacent to the limiting member 32 has a concave part 3311, and a cross-sectional area of the first end of the body 331 is greater than a cross-sectional area of the second end of the body 331. Specifically, the arrangement of the concave part 3311 makes it difficult for the side of the body 331 adjacent to the limiting member 32 to contact the outer peripheral surface of the limiting member 32 when the insertion block 332 is fitted with the recess 321, thereby reducing friction.

Referring back to FIG. 1, in some embodiments, for example, the locking device 3 may further include a wear-reducing ring 35 and a fixed cover 36. The wear-reducing ring 35 is fitted over the first end of the active shaft, and the wear-reducing ring 35 is positioned between the limiting member 32 and the connecting plate 31, e.g., to reduce friction between the limiting member 32 and the connecting plate 31 and prolong a service life of the locking device 3. The fixed cover 36 is arranged on the side of the connecting plate 31 away from the telescoping mechanism 2. The limiting member 32 and the toggle member 33 are positioned between the fixed cover 36 and the connecting plate 31. At least a part of the driving member 34 passes through the fixed cover 36 and is coupled to the toggle member 33.

Specifically, the fixed cover 36 is fixedly coupled to the connecting plate 31. An installation space (not shown) is formed between the fixed cover 36 and the connecting plate 31. The limiting member 32 and the toggle member 33 are positioned in the installation space to stabilize the installation of the limiting member 32 and the toggle member 33, which improves the integrity and the fitting degree of the locking device 3 and ensures close fit among components of the locking device 3.

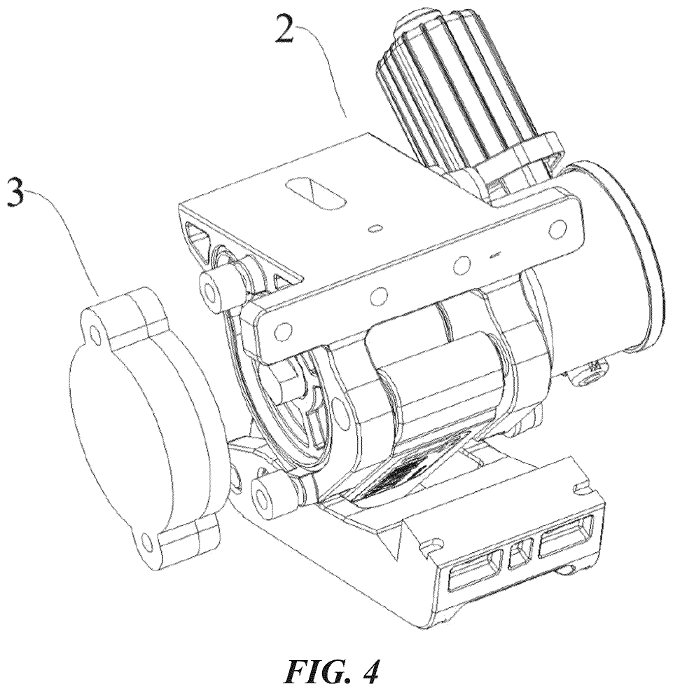

The structure of the locking device 3 is not limited to the above description. Referring to FIG. 4, in some embodiments, for example, the locking device 3 may include a limiting disc 41, an electromagnet 42, and an electromagnetic fixing cap 43. A first end of the limiting disc 41 is coupled to the first end of the active shaft of the telescoping mechanism 2. Specifically, the first end of the limiting disc 41 is provided with a flat bore 411, which is fitted with the first end of the active shaft of the telescoping mechanism 2 so that the limiting disc 41 is firmly coupled to the first end of the active shaft of the telescoping mechanism 2. The limiting disc 41 can rotate with the active shaft of the telescoping mechanism 2.

At least a part of the electromagnet 42 is fitted with a second end of the limiting disc 41. When the electromagnet 42 is energized, at least a part of the electromagnet 42 is coupled to the second end of the limiting disc 41, and the limiting disc 41 restricts rotation of the active shaft of the telescoping mechanism 2, thereby limiting the position of the step 1. When the electromagnet 42 is de-energized, at least a part of the electromagnet 42 is disconnected with the second end of the limiting disc 41, and the active shaft of the telescoping mechanism is rotatable, which allows the step 1 to rotate with the active shaft of the telescoping mechanism 2. Specifically, the second end of the limiting disc 41 has a through hole 412. When the electromagnet 42 is energized, at least a part of the electromagnet 42 is fitted with the through hole 412. When the electromagnet 42 is de-energized, at least a part of the electromagnet 42 is separated from the through hole 412.

The electromagnetic fixing cap 43 is arranged on the telescoping mechanism 2. The limiting disc 41 is positioned between the electromagnetic fixing cap 43 and the telescoping mechanism 2. The electromagnet 42 is mounted on the electromagnetic fixing cap 43, and at least a part of the electromagnet 42 is fitted with the limiting disc 41 by the electromagnetic fixing cap 43. The arrangement of the electromagnetic fixing cap 43 improves the integrity and the fitting degree of the locking device 3 and ensures close fit among the components of the locking device 3.

In some embodiments, for example, the locking device 3 is an electromagnetic brake. Specifically, the electromagnetic brake is arranged on the telescoping mechanism 2 and coupled to the active shaft of the telescoping mechanism 2. When the electromagnetic brake is energized, the brake opens and locks the telescoping mechanism 2 so that the step 1 remains stable. When the electromagnetic brake is de-energized, the brake is closed, and the telescoping mechanism 2 can drive the step 1 to move.

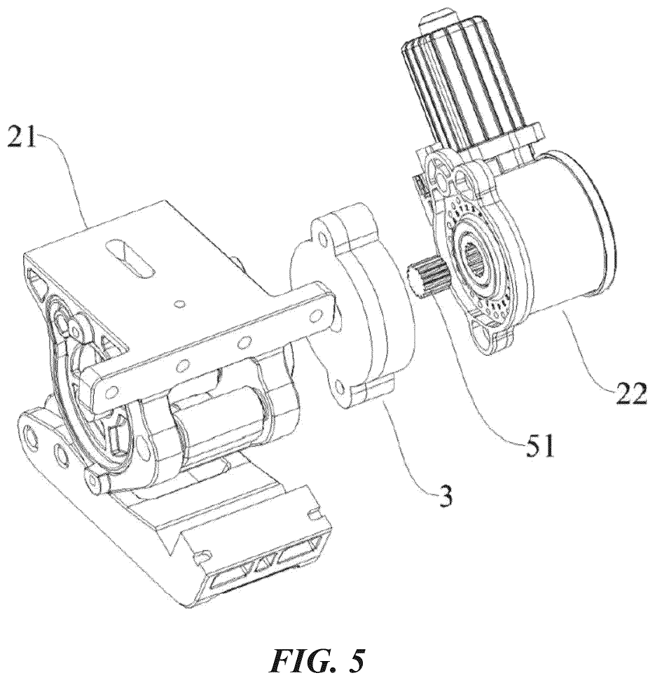

Referring to FIG. 5, in some embodiments, for example, the telescoping mechanism includes a telescoping device 21 and a motor 22, and the motor 22 is coupled to the telescoping device 21. The locking device 3 is arranged between the telescoping device 21 and the motor 22, and the locking device 3 is coupled to the telescoping device 21 and the motor 22. The motor 22 locks the telescoping device 21 by driving the locking device 3 to rotate.

Specifically, the locking device 3 is a brake member arranged between the telescoping device 21 and the motor 22. There is a connecting shaft 51 between the brake member and the motor 22, and the motor 22 is coupled to the brake member through the connecting shaft 51. The motor 22 opens the brake member by driving the connecting shaft 51 to rotate forward and reverse. At this time, the brake will not lock the telescoping device 21. Then, the motor 22 adjusts the position of the step 1 by driving the telescoping device 21. When the position of the step 1 is determined, the motor 22 drives the active shaft of the telescoping device 21 to rotate reversely. At this time, the brake is applied and locks the telescoping mechanism 2 to keep the step 1 stable.

Therefore, the locking device 3 of the electric step with the locking function in embodiments of the present technology has various kinds of implementations, and each kind of locking device 3 is easy to operate during use, which improves the practicality and an applicability of the electric step 1.

### EXAMPLES

Embodiments of an electric step with locking function in accordance with the present technology includes the following examples.

In some embodiments in accordance with the present technology (example 1), an electric step with a locking function includes a step mounted on a vehicle; a telescoping mechanism mounted on the vehicle and coupled to the step, the telescoping mechanism being configured to drive the step to move between a first position and a second position relative to the vehicle, wherein when the step is in the first position, the step is in an extended state, and when the step is in the second position, the step is in a retracted state, and wherein there is an angle between the first position and the second position; and a locking device arranged on the telescoping mechanism and configured to lock the step at the first position, at the second position, or at any position between the first position and the second position.

Example 2 includes the electric step according to example 1 or any of examples 1-11, wherein the locking device comprises a connecting plate arranged on the telescoping mechanism, wherein a first end of an active shaft of the telescoping mechanism is configured to pass through the connecting plate; a limiting member positioned on a side of the connecting plate away from the telescoping mechanism and coupled to the first end of the active shaft, wherein an outer peripheral surface of the limiting member has a recess; a toggle member arranged on the side of the connecting plate away from the telescoping mechanism and rotatable relative to the connecting plate, wherein at least a part of the toggle member is configured to fit with the recess of the limiting member; and a driving member coupled to the toggle member, the driving member configured to drive the toggle member to rotate, allowing the at least a part of the toggle member to fit with the recess or to detach from the recess.

Example 3 includes the electric step according to example 2 or any of examples 1-11, wherein the limiting member includes a plurality of recesses, and the plurality of recesses are arranged at intervals around a peripheral direction of the outer peripheral surface of the limiting member.

Example 4 includes the electric step according to example 3 or any of examples 1-11, wherein a cross-sectional area of each recess of the plurality of recesses gradually decreases from a first end of the recess away from a center of the limiting member to a second end of the recess adjacent to the center of the limiting member.

Example 5 includes the electric step according to example 2 or any of examples 1-11, wherein the toggle member comprises a body and an insertion block, wherein a first end of the body is rotatably coupled to the side of the connecting plate away from the telescoping mechanism, and the insertion block is arranged at a second end of the body and is fitted with the recess of the limiting member.

Example 6 includes the electric step according to example 5 or any of examples 1-11, wherein a side of the body of the toggle member that is adjacent to the limiting member has a concave part, and wherein a cross-sectional area of the first end of the body is greater than a cross-sectional area of the second end of the body.

Example 7 includes the electric step according to example 2 or any of examples 1-11, wherein the locking device further comprises a wear-reducing ring fitted over the first end of the active shaft and positioned between the limiting member and the connecting plate; and a fixed cover arranged on the side of the connecting plate away from the telescoping mechanism, wherein the limiting member and the toggle member are between the fixed cover and the connecting plate, and at least a part of the driving member passes through the fixed cover and is coupled to the toggle member.

Example 8 includes the electric step according to example 1 or any of examples 1-11, wherein the locking device comprises a limiting disc, wherein a first end of the limiting disc is coupled to a first end of an active shaft of the telescoping mechanism; an electromagnet, wherein at least a part of the electromagnet is fitted with a second end of the limiting disc, and wherein when the electromagnet is energized, at least the part of the electromagnet is coupled to the second end of the limiting disc and the limiting disc restricts rotation of the active shaft of the telescoping mechanism, and when the electromagnet is de-energized, at least the part of the electromagnet is disconnected with the second end of the limiting disc and the active shaft of the telescoping mechanism is rotatable; and an electromagnetic fixing cap arranged on the telescoping mechanism, wherein the limiting disc is positioned between the electromagnetic fixing cap and the telescoping mechanism, and at least the part of the electromagnet is fitted with the limiting disc through the electromagnetic fixing cap.

Example 9 includes the electric step according to example 1 or any of examples 1-11, wherein the locking device is an electromagnetic brake.

Example 10 includes the electric step according to example 1 or any of examples 1-11, wherein the telescoping mechanism comprises a telescoping device and a motor coupled to the telescoping device.

Example 11 includes the electric step according to example 10 or any of examples 1-9, wherein the locking device is arranged between the telescoping device and the motor and coupled to the telescoping device and the motor, and wherein the motor locks the telescoping device by driving the locking device to rotate.

### Conclusion

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. For example, the driving member 34 can include a control unit embodying various systems, digital electronic circuitry, or in computer software, firmware, or hardware, which structurally and/or functionally interfaced with a driving mechanism (e.g., motor) of the driving member.

Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., FPGA (field programmable gate array) or ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

In the specification, it is to be understood that terms such as “central,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” and “circumferential” should be construed to refer to the orientation as then described or as shown in the drawings under discussion. These relative terms are for convenience of description and do not indicate or imply that the present technology must have a particular orientation or be constructed and operated in a particular orientation. Thus, these terms shall not be construed as limitation on the present technology.

In addition, terms such as “first” and “second” are used herein for purposes of description and are not intended to indicate or imply relative importance or significance or to imply the number of indicated technical features. Thus, the feature defined with “first” and “second” may include one or more of this feature. In the description of the present disclosure, the term “a plurality of” means at least two, such as two or three, unless specified otherwise.

In the present disclosure, unless specified or limited otherwise, the terms “mounted,” “connected,” “coupled,” “fixed,” and the like are used broadly and may be, for example, fixed connections, detachable connections, or integral connections; may also be mechanical or electrical connections; may also communicate with each other; may also be direct connections or indirect connections via intervening structures; and may also be inner connections or mutual interactions of two elements, which can be understood by those skilled in the art according to specific situations.

In the present disclosure, unless specified or limited otherwise, a structure in which a first feature is “on” or “below” a second feature may include an embodiment in which the first feature is in direct contact with the second feature and may also include an embodiment in which the first feature and the second feature are not in direct contact with each other but are contacted via an additional feature formed therebetween. Furthermore, a first feature “on,” “above,” or “on top of” a second feature may include an embodiment in which the first feature is right or obliquely “on,” “above,” or “on top of” the second feature or just means that the first feature is at a height higher than that of the second feature, while a first feature “below,” “under,” or “on bottom of” a second feature may include an embodiment in which the first feature is right or obliquely “below,” “under,” or “on bottom of” the second feature or just means that the first feature is at a height lower than that of the second feature.

Reference throughout this specification to “an embodiment,” “some embodiments,” “an example,” “a specific example,” or “some examples” means that a particular feature, structure, material, or characteristic described in connection with the embodiment or example is included in at least one embodiment or example of the present technology. Thus, the appearances of these phrases in various places throughout this specification are not necessarily referring to the same embodiment or example of the present technology. Furthermore, the particular features, structures, materials, or characteristics may be combined in any suitable manner in one or more embodiments or examples. Moreover, different embodiments or examples as well as features in different embodiments or examples described in this specification may be combined and united by those skilled in the art in case of no mutual contradiction.

Although some embodiments have been shown and described, it can be understood that the above embodiments are illustrative and shall not be understood as limitation on the present technology. Any changes, modifications, alternatives, and variations made by those skilled in the art to the above embodiments are within the scope of protection of the present technology.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. An electric step with a locking function, comprising:
a step mounted on a vehicle;
a telescoping mechanism mounted on the vehicle and coupled to the step, the telescoping mechanism being configured to drive the step to move between a first position and a second position relative to the vehicle, wherein when the step is in the first position, the step is in an extended state, and when the step is in the second position, the step is in a retracted state, and wherein there is an angle between the first position and the second position; and
a locking device arranged on the telescoping mechanism and configured to lock the step at the first position, at the second position, or at any position between the first position and the second position.

2. The electric step according to claim 1, wherein the locking device comprises:
a connecting plate arranged on the telescoping mechanism, wherein a first end of an active shaft of the telescoping mechanism is configured to pass through the connecting plate;
a limiting member positioned on a side of the connecting plate away from the telescoping mechanism and coupled to the first end of the active shaft, wherein an outer peripheral surface of the limiting member has a recess;
a toggle member arranged on the side of the connecting plate away from the telescoping mechanism and rotatable relative to the connecting plate, wherein at least a part of the toggle member is configured to fit with the recess of the limiting member; and
a driving member coupled to the toggle member, the driving member configured to drive the toggle member to rotate, allowing the at least a part of the toggle member to fit with the recess or to detach from the recess.

3. The electric step according to claim 2, wherein the limiting member includes a plurality of recesses, and the plurality of recesses are arranged at intervals around a peripheral direction of the outer peripheral surface of the limiting member.

4. The electric step according to claim 3, wherein a cross-sectional area of each recess of the plurality of recesses gradually decreases from a first end of the recess away from a center of the limiting member to a second end of the recess adjacent to the center of the limiting member.

5. The electric step according to claim 2, wherein the toggle member comprises a body and an insertion block, wherein a first end of the body is rotatably coupled to the side of the connecting plate away from the telescoping mechanism, and the insertion block is arranged at a second end of the body and is fitted with the recess of the limiting member.

6. The electric step according to claim 5, wherein a side of the body of the toggle member that is adjacent to the limiting member has a concave part, and wherein a cross-sectional area of the first end of the body is greater than a cross-sectional area of the second end of the body.

7. The electric step according to claim 2, wherein the locking device further comprises:
a wear-reducing ring fitted over the first end of the active shaft and positioned between the limiting member and the connecting plate; and
a fixed cover arranged on the side of the connecting plate away from the telescoping mechanism, wherein the limiting member and the toggle member are between the fixed cover and the connecting plate, and at least a part of the driving member passes through the fixed cover and is coupled to the toggle member.

8. The electric step according to claim 1, wherein the locking device comprises:
a limiting disc, wherein a first end of the limiting disc is coupled to a first end of an active shaft of the telescoping mechanism;
an electromagnet, wherein at least a part of the electromagnet is fitted with a second end of the limiting disc, and wherein when the electromagnet is energized, at least the part of the electromagnet is coupled to the second end of the limiting disc and the limiting disc restricts rotation of the active shaft of the telescoping mechanism, and when the electromagnet is de-energized, at least the part of the electromagnet is disconnected with the second end of the limiting disc and the active shaft of the telescoping mechanism is rotatable; and
an electromagnetic fixing cap arranged on the telescoping mechanism, wherein the limiting disc is positioned between the electromagnetic fixing cap and the telescoping mechanism, and at least the part of the electromagnet is fitted with the limiting disc through the electromagnetic fixing cap.

9. The electric step according to claim 1, wherein the locking device is an electromagnetic brake.

10. The electric step according to claim 1, wherein the telescoping mechanism comprises a telescoping device and a motor coupled to the telescoping device.

11. The electric step according to claim 10, wherein the locking device is arranged between the telescoping device and the motor and coupled to the telescoping device and the motor, and wherein the motor locks the telescoping device by driving the locking device to rotate.
